(19) United States
(12) Patent Application Publication
(10) Pub. No.: US 2007/0138753 A1
(43) Pub. Date: Jun. 21, 2007

(54) LUGGAGE CART

(76) Inventor: Ming-Hsing Huang, Tai-Dong (TW)

Correspondence Address: PAI PATENT & TRADEMARK LAW FIRM, 1001 FOURTH AVENUE, SUITE 3200, SEATTLE, WA, 98154, US

(21) Appl. No.: 11/306,142

(22) Filed: Dec. 16, 2005

(51) Int. Cl. B62B 1/00

(52) U.S. Cl. 280/47.2

(57) ABSTRACT

A luggage cart is disclosed, which comprises a supplementary support device equipped with a roller and pivoted to the back side of the cart body of the luggage cart and turnable relative to the cart body between a first position where the supplementary support device is closely attached to the back side of the cart body, and a second position where the supplementary support device works with the wheels at the back side of the cart body to support the luggage cart stably on the floor in a tilted position.

### BACKGROUND OF THE INVENTION

1. Field of the Invention

The present invention relates to a luggage cart and more particularly to a luggage cart which is equipped with a supplementary support device for supporting the luggage cart on the floor stably in a tilted position.

2. Description of the Related Art

A conventional luggage cart, as shown in FIG. 1, comprises a cart body 7 for holding things, a plurality of wheels 9 respectively pivotally provided at the bottom side of the cart body 7 to make the cart body 7 easy to move, and a handle 8 provided at the top side of the cart body 7. When moving the luggage cart on the floor, the luggage cart is kept in a tilted position (see FIG. 1). At this time, the user's hand receives much pressure from the load carried in the cart body 7 and will soon feel uncomfortable.

### SUMMARY OF THE INVENTION

The present invention has been accomplished under the circumstances in view. It is one object of the present invention to provide a luggage cart which is equipped with a supplementary support device for supporting the luggage cart on the floor stably in a tilted position. It is another object of the present invention to provide a luggage cart which is equipped with a supplementary support device that allows the user to move the luggage cart on the floor in a tilted position with less effort. To achieve these and other objects of the present invention, the luggage cart comprises a cart body, a plurality of wheels respectively pivotally provided at the bottom side of the cart body, and a handle provided at the top side of the cart body. The cart body is provided with a supplementary support device for supporting the cart body on a flat surface in a tilted position. The supplementary support device comprises a frame pivoted to the cart body and turnable relative to the cart body between an extended position and a received position, and at least one roller pivotally mounted on the bottom side of the frame opposite to the pivoted joint between the cart body and the frame.

### BRIEF DESCRIPTION OF THE DRAWINGS

FIG. 1 is a schematic drawing showing how a luggage cart according to the prior art is used.

FIG. 2 is a schematic drawing showing how a luggage cart according to the present invention is used.

FIG. 3 is an elevational view of the luggage cart according to the present invention.

FIG. 4 is another elevational view of the present invention, showing an alternate form of the supplementary support device.

FIG. 5 is a schematic drawing of a part of the present invention, showing the arrangement of the spring member and the lock in between the cart body and the supplementary support device.

FIG. 6 is a schematic drawing of the present invention, showing the supplementary support device received to the back side of the cart body.

FIG. 7 is a sectional view of a part of the present invention, showing the supplementary support device received to the cart body and secured to a retaining groove at the back side of the cart body.

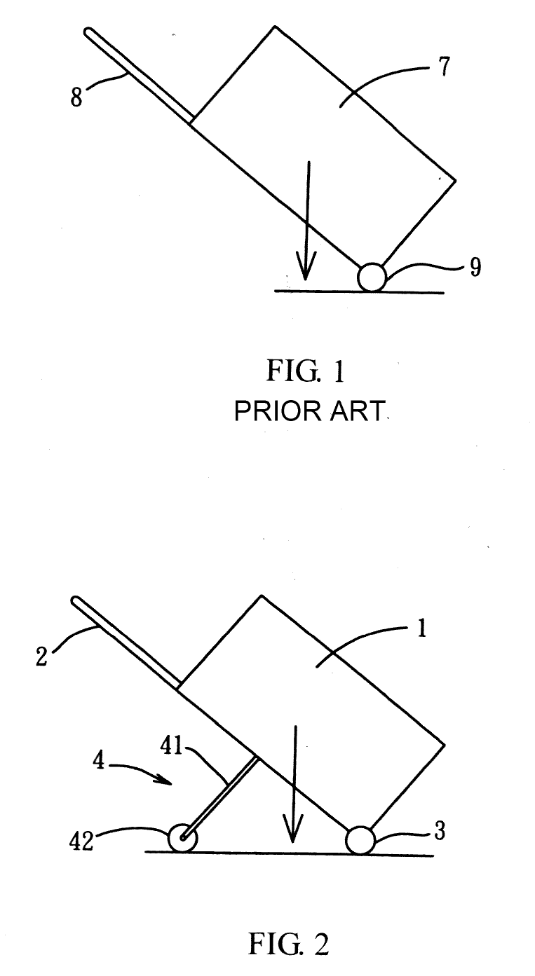

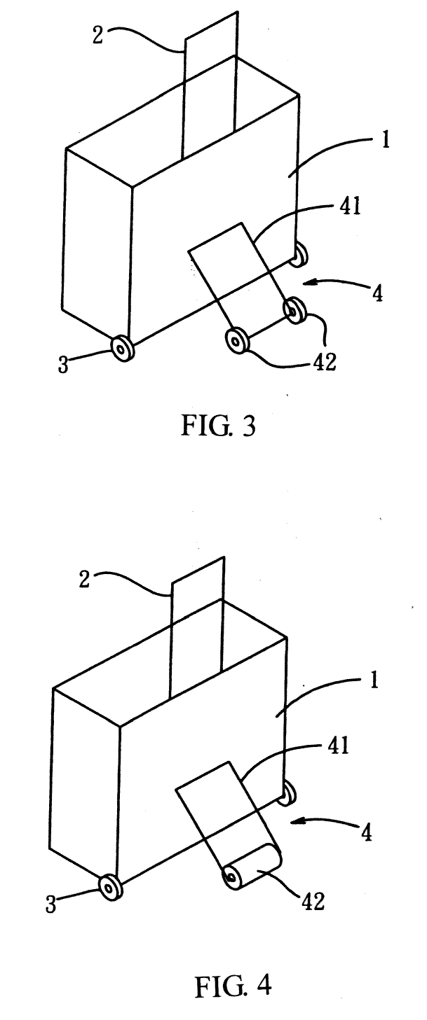

### DETAILED DESCRIPTION OF THE PREFERRED EMBODIMENT

Referring to FIGS. 2˜4, a luggage cart in accordance with the present invention is shown comprised of a cart body 1, a handle 2, a number of wheels 3, and a supplementary support device 4.

The cart body 1 is adapted to carry things. According to this embodiment, the cart body 1 is a box frame. Alternatively, the cart body 1 can be made in the shape of the frame structure of a golf cart for carrying a golf bag.

The handle 2 is provided at the top side of the cart body 1. Through the handle 2, the user can move the luggage cart on the floor with less effort. Further, the handle 2 can be a retractable handle. Because the handle 2 is well known in the prior art, no further detailed description in this regard is necessary.

The wheels 3 are respectively pivotally provided at the bottom side of the cart body 1 to make the cart body 1 easy to move.

The supplementary support device 4 comprises a frame 41 and at least one roller 42. The frame 41 has one end, namely, the top end, pivotally coupled to one side, namely, the back side, of the cart body 1, and the other end, namely, the bottom end, carrying the at least one roller 42. The supplementary support device 4 can be turned outwards from the cart body 1 to support the cart body 1 on the floor in a tilted position (see FIG. 2). In this case, the cart body 1 is stably supported on the floor at three bearing points, i.e., the two wheels 3 at the back side of the cart body 1 and the roller 42 of the supplementary support device 4 support the cart body 1 stably on the floor. Thus, the user can move the luggage cart in this tilted position smoothly with less effort. The user can also release the hand from the luggage cart to do other things, for example, to have a meal, to pick up a telephone, to buy a ticket, leaving the luggage cart stably on the floor in the tilted position.

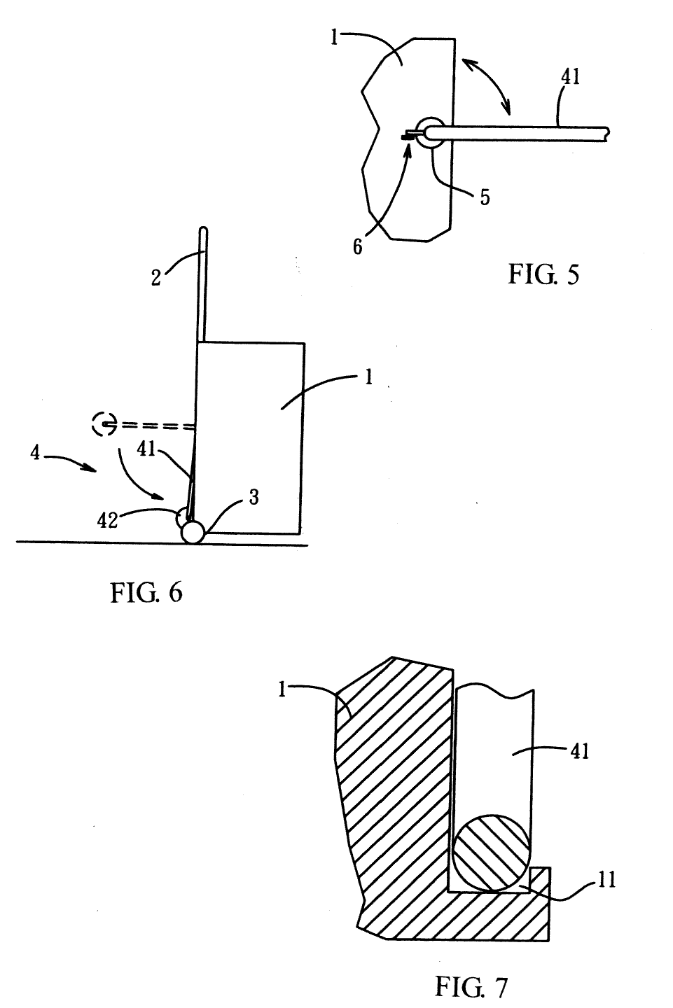

Referring to FIGS. 5 and 6, a spring member 5 is provided between the cart body 1 and the frame 41 of the supplementary support device 4 and adapted to hold the supplementary support device 4 in the received (non-operative) position where the supplementary support device 4 is closely attached to the back side of the cart body 1 (see FIG. 6. Further, a lock 6 is provided for locking the supplementary support device 4 in the extended (operative) position (see FIG. 5).

Referring to FIG. 7, the card body 1 has a retaining groove 11 adapted to receive a part of the supplementary support device 4, holding the supplementary support device 4 firmly in the received (non-operative) position.

A prototype of luggage cart has been constructed with the features of FIGS. 2˜7. The luggage cart functions smoothly to provide all of the features discussed earlier.

Although particular embodiments of the invention have been described in detail for purposes of illustration, various modifications and enhancements may be made without departing from the spirit and scope of the invention.

What is claimed is:

1. A luggage cart comprising
a cart body,
a plurality of wheels respectively pivotally provided at a bottom side of said cart body,
a handle provided at a top side of said cart body, and
a supplementary support device, said supplementary support device comprising a frame and at least one roller pivotally mounted on a bottom side of said frame,
wherein a top side of said frame is pivoted to a back side of said cart body and turnable relative to said cart body between an extended position, where said supplementary support device, together with said plurality of wheels, can support said cart body on a flat surface in a tilted position, and a received position, where said supplementary support device is closely attached to the back side of said cart body.

2. The luggage cart as claimed in claim 1, further comprising a spring member coupled between the back side of said cart body and said frame of said supplementary support device and adapted to hold said frame of said supplementary support device in said received position.

3. The luggage cart k as claimed in claim 2, further comprising a lock means adapted to lock said frame to said cart body in said extended position.
